(19) United States
(12) Patent Application Publication
(10) Pub. No.: US 2009/0003443 A1
(43) Pub. Date: Jan. 1, 2009

(54) PRIORITY-BASED TEMPLATE MATCHING INTRA PREDICTION VIDEO AND IMAGE CODING

(75) Inventors: Yi Guo, Hefei (CN); Ye-Kui Wang, Tampere (FI); Houqiang Li, Hefei (CN)

Correspondence Address: FOLEY & LARDNER LLP, P.O. BOX 80278, SAN DIEGO, CA, 92138-0278, US

(73) Assignee: Nokia Corporation

(21) Appl. No.: 12/146,338

(22) Filed: Jun. 25, 2008

Related U.S. Application Data
(60) Provisional application No. 60/946,390, filed on Jun. 26, 2007.

(51) Int. Cl. H04N 7/12; H04N 11/02; H04N 7/26

(52) U.S. Cl. 375/240.13; 375/240.16; 382/238; 375/E07.133; 375/E07.147

(57) ABSTRACT

Template matching intra prediction based on a given priority is provided. Priority values of all, or a subset of the pixels on a border between a current block and a reconstructed area are calculated. A border pixel with the highest priority is used as the center of a template block. A search for the best matched candidate template is performed in the reconstructed area. Distortion metrics between known pixels in the to-match template and corresponding pixels in candidate templates are calculated and compared. The candidate template with the smallest distortion metric value is chosen as the best match. Corresponding pixels of the best-matched candidate template in the searching area are used as predictors of the unknown pixels in the template centered at the pixel with the highest priority, and the predicted pixels are marked as known. The process is repeated until all pixels in the current block are marked as known.

### FIELD OF THE INVENTION

The present invention relates generally to video coding. More particularly, the present invention relates to template matching intra prediction in video coding processes.

### BACKGROUND OF THE INVENTION

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

Video coding standards include ITU-T H.261, ISO/IEC MPEG-1 Visual, ITU-T H.262 or ISO/IEC MPEG-2 Visual, ITU-T H.263, ISO/IEC MPEG-4 Visual and ITU-T H.264 (also known as ISO/IEC MPEG-4 AVC). In addition, there are currently efforts underway with regards to the development of new video coding standards. One such standard under development is the SVC standard, which will become the scalable extension to H.264/AVC. Another standard under development is the multi-view coding standard (MVC), which is also an extension of H.264/AVC. Yet another such effort involves the development of China video coding standards.

A draft of the SVC standard is described in JVT-V201, “Joint Draft 9 of SVC Amendment”, 22^{nd} JVT meeting, Marrakech, Morocco, January 2007, available at http://ftp3.1tu.ch/av-arch/jvt-site/2007_{—}01_Marrakech/JVT-V201.zip. A draft of the MVC standard is described in JVT-V209, “Joint Draft 2.0 on Multiview Video Coding”, 22^{nd} JVT meeting, Marrakech, Morocco, January 2007, available at http://ftp3.1tu.ch/av-arch/jvt-site/2007_{—}01_Marrakech/JVT-V209.zip.

In general, conventional video coding standards (e.g., MPEG-1, H.261/263/264) incorporate intra-frame or inter-frame predictions which can be used to remove redundancies within a frame or among the video frames in multimedia applications and services. In a typical single-layer video codec, like H.264, a video frame is processed in macroblocks. If the macroblock (MB) is an inter-MB, the pixels in one MB can be predicted from the pixels in one or more reference frames. If the macroblock is an intra-MB, the pixels in the MB in the current frame can be predicted entirely from the pixels, that were already coded (or decoded), in the same video frame.

For both inter-MB and intra-MB, the MB can be decoded by decoding the syntax elements of the MB. Based on syntax elements, the pixel predictors for each partition of MB can be retrieved. Entropy decoding is performed to obtain the quantized coefficients, and inverse transformation is performed on the quantized coefficients to reconstruct the prediction residual; and. Additionally, pixel predictors can be added to the reconstructed prediction residuals to obtain the reconstructed pixel values of the MB.

At the encoder side, the prediction residuals can be the difference between the original pixels and their predictors. The residuals can be transformed and the transform coefficients can be quantized. The quantized coefficients can then be encoded using certain entropy-coding schemes. If the MB is an inter-MB, the following information related to mode decision can be coded. For example, using H.264 as an example, the information can include: an MB type to indicate whether this is an inter-MB; specific inter-frame prediction modes that are used, where the prediction modes indicate how the MB is partitioned, e.g., the MB can have one partition of size 16×16, or two 16×8 partitions and each partition can have different motion information, and so on; one or more reference frame indices to indicate the reference frames from which the pixel predictors are obtained, where different parts of an MB can have predictors from different reference frames; and one or more motion vectors to indicate the locations on the reference frames where the predictors are fetched.

If the MB is an intra-MB, the following information can be coded, where H.264 is again as an example: MB type to indicate that this is an intra-MB; intra-frame prediction modes used for luma, where if the luma signal is predicted using the intra4×4 mode, then each 4×4 block in the 16×16 luma block can have its own prediction mode, and sixteen intra4×4 modes can be coded for an MB. If the luma signal is predicted using the intra16×16 mode, then one intra16×16 mode be associated with the entire MB; and an intra-frame prediction mode used for chroma. It should be noted that enhancements made to intra prediction in successive video coding standards, e.g., more intra prediction modes, can lead to enhanced coding efficiency.

Intra prediction is used in H.264/AVC to remove spatial redundancy by referring to neighboring samples of previously coded blocks which are to the left of and/or above the to-be-coded block. For luminance samples (i.e., samples of luminance components of a video signal), the size of the intra prediction mode can be 4×4 (Intra4×4), 8×8 (Intra8×8) or 16×16 (Intra16×16). Nine prediction modes (e.g., eight directional modes and one DC mode) for Intra4×4 and Intra8×8 can be used, where the eight directional prediction modes are shown in FIG. 1. Additionally, four prediction modes (horizontal, vertical, DC, and plane modes) can be used for Intral 6×16 luma and for the chrominance components. Details about the intra prediction process are described in ISO/IEC JTC 1 and ITU-T, “H.264/AVC—Advanced Video Coding for Generic Audiovisual Services”, ITU-T Recommendation H.264 and ISO/IEC 14496-10 (MPEG-4 part 10), version 3, 2005.

A video codec comprises an encoder that transforms input video into a compressed representation suited for storage and/or transmission and a decoder that can uncompress the compressed video representation back into a viewable form. FIG. 2, for example, is a block diagram of a conventional video encoder. More particularly, FIG. 2 shows how an image to be encoded 200 undergoes pixel prediction 202, prediction error coding 203 and prediction error decoding 204. For pixel prediction 202, the image 200 undergoes both inter-prediction 206 and intra-prediction 208 which, after mode selection 210, results in a prediction representation of an image block 212. A preliminary reconstructed image 214 is also used for intra-prediction 208. Once all of the image blocks are processed, the preliminary reconstructed image 214 undergoes filtering at 216 to create a final reconstructed image 240, which is sent to a reference frame memory 218 and is also used for inter-prediction 206 of future frames.

The prediction representation of the image block 212, as well as the image to be encoded 200, are used together to define a prediction error signal 220 which is used for prediction error coding 203. In prediction error coding 203, the prediction error signal 220 undergoes transform 222 and quantization 224. The data describing prediction error and predicted representation of the image block 212 (e.g., motion vectors, mode information, and quantized transform coefficients) are passed to entropy coding 226. The prediction error decoding 204 is substantially the opposite of the prediction error coding 203, with the prediction error decoding including an inverse quantization 228 and an inverse transform 230. The result of the prediction error decoding 204 is a reconstructed prediction error signal 232, which is used in combination with the predicted representation of the image block 212 to create the preliminary reconstructed image 214.

The decoder reconstructs output video by applying prediction mechanisms that are similar to those used by the encoder in order to form a predicted representation of the pixel blocks (using motion or spatial information created by the encoder and stored in the compressed representation). Additionally, the decoder utilizes prediction error decoding (the inverse operation of the prediction error coding, recovering the quantized prediction error signal in the spatial pixel domain). After applying the prediction and prediction error decoding processes, the decoder sums up the prediction and prediction error signals (i.e., the pixel values) to form the output video frame. The decoder (and encoder) can also apply additional filtering processes in order to improve the quality of the output video before passing it on for display and/or storing it as a prediction reference for the forthcoming frames in the video sequence.

FIG. 3, for example, is a block diagram of a conventional video decoder. As shown in FIG. 3, entropy decoding 300 is followed by both prediction error decoding 302 and pixel prediction 304. In prediction error decoding 302, an inverse quantization 306 and inverse transform 308 is used, ultimately resulting in a reconstructed prediction error signal 310. For pixel prediction 304, either intra-prediction or inter-prediction occurs at 312 to create a predicted representation of an image block 314. The predicted representation of the image block 314 is used in conjunction with the reconstructed prediction error signal 310 to create a preliminary reconstructed image 316, which in turn can be used for inter-prediction or intra-prediction at 312. Once all of the image blocks have been processed, the preliminary reconstructed image 316 is passed for filtering 318. The filtered image can either be output as a final reconstructed image 320, or the filtered image can be stored in reference frame memory 322, making it usable for prediction 312.

In conventional video codecs, such as that described above, motion information is indicated by motion vectors associated with each motion-compensated image block. Each of these motion vectors represents the displacement of the image block in the picture to be coded (at the encoder side) or decoded (at the decoder side). Additionally, each of these motion vectors also represents the prediction source block in one of the previously coded or decoded pictures. In order to represent motion vectors efficiently, motion vectors are typically coded differentially with respect to block-specific predicted motion vectors. For example, in a conventional video codec, the predicted motion vectors are created in a predefined way by calculating the median of the encoded or decoded motion vectors of adjacent blocks.

Conventional video encoders utilize Lagrangian cost functions to find optimal coding modes, e.g., the desired macroblock mode and associated motion vectors, where a macroblock can comprise, for example, a block of 16×16 pixels. This kind of cost function uses a weighting factor λ to tie together the exact or estimated image distortion due to lossy coding methods and the exact or estimated amount of information that is required to represent the pixel values in an image area:

C=D+λ×R (1)

In Eq. (1), C is the Lagrangian cost to be minimized, D is the image distortion (e.g., the mean squared error) with the mode and motion vectors considered, and R is the number of bits needed to represent the required data to reconstruct the image block in the decoder (including the amount of data to represent the candidate motion vectors).

According to conventional video encoders and decoders, e.g., H.264, intra prediction is based upon directional patterns, where the intra prediction direction needs to be signaled from the encoder to the decoder. Performing template matching intra prediction in alternative pixel orders can improve the coding efficiency.

### SUMMARY OF THE INVENTION

Various embodiments of the present invention allow for the performance of template matching intra prediction based on a given priority. Priority values of all, or a subset of the pixels on a border between a current N×N block and a reconstructed area are calculated. A border pixel p with the highest priority is used as the center of a template M×M block, and a search in the reconstructed area is performed to find the best matched candidate template. Distortion metrics, e.g., Sum of Absolute Difference (SAD), between known pixels in the to-match template and corresponding pixels in candidate templates are calculated and compared. The candidate template with the smallest distortion metric value is chosen as the best match. The corresponding pixels of the best-matched candidate template in the searching area are used as the predictors of the unknown pixels in the template centered at the pixel p with the highest priority, and the predicted pixels are marked as known. If all of the pixels in the current N×N block are not marked as known, the process is repeated. Coding efficiency in video and image coding, for example, can then be improved by utilizing template matching intra predication in accordance with the various embodiments.

In accordance with other aspects of various embodiments of the present invention, priority can be described as a rule, for example, which prioritizes certain points over others. This results in a sequence of template blocks that are processed according to a particular order. In other words, priority can alternatively be achieved through processes that favor one template block over others at each stage of intra prediction in the N×N block.

These and other features of the invention, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

FIG. 1 is a diagrammatic representation of the nine directional intra prediction modes that may be utilized in accordance with H.264 intra prediction of luminance sample.

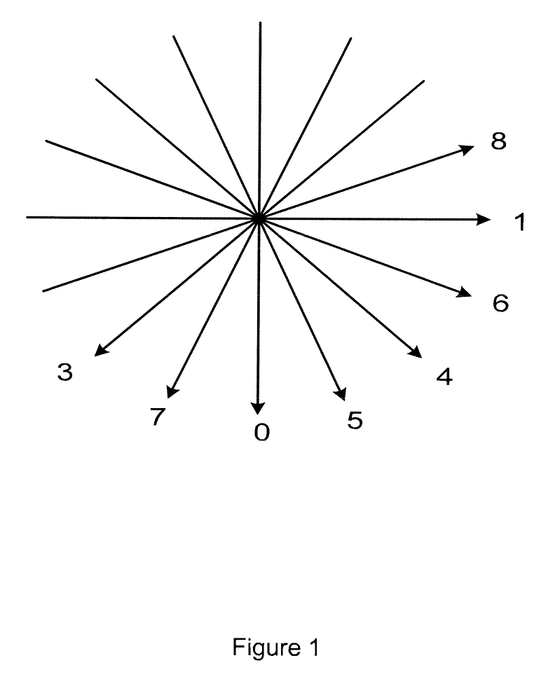

FIG. 2 is a block diagram of a conventional video encoder;

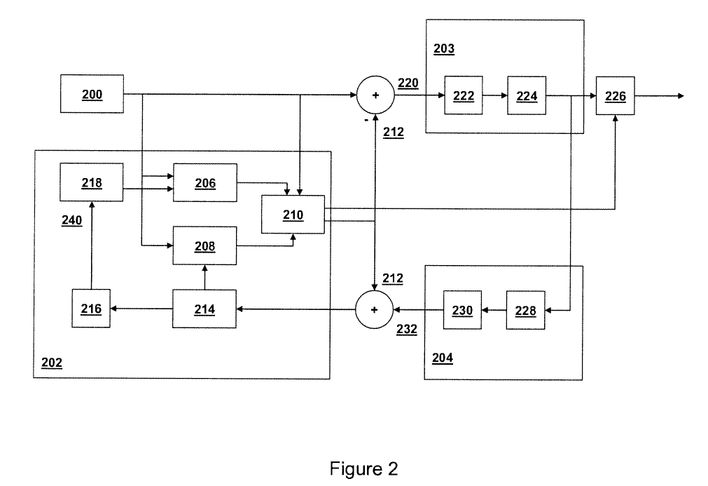

FIG. 3 is a block diagram of a conventional video decoder;

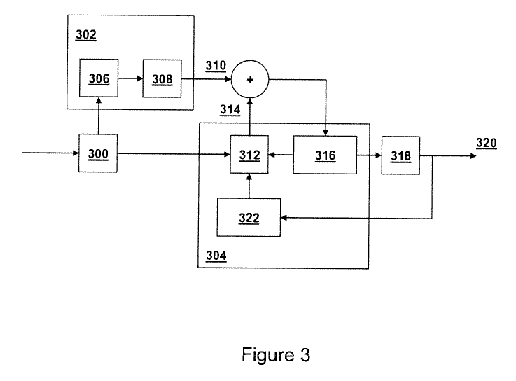

FIG. 4 is an overview diagram of a system within which the present invention may be implemented;

FIG. 5 is a perspective view of a mobile telephone that can be used in the implementation of the present invention;

FIG. 6 is a schematic representation of the telephone circuitry of the mobile telephone of FIG. 5;

FIG. 7 is a flow chart of processes performed in accordance with various embodiments of the present invention;

FIG. 8 shows a searching region of reconstructed pixels, a current block to be intra predicted in accordance with various embodiments of the present invention;

FIG. 9 shows the searching region of FIG. 8 and the current block after filling in candidate data in accordance with various embodiments of the present invention;

FIG. 10 illustrates a mask for representing known and unknown pixels in accordance with various embodiments of the present invention;

### DETAILED DESCRIPTION OF THE PREFERRED EMBODIMENTS

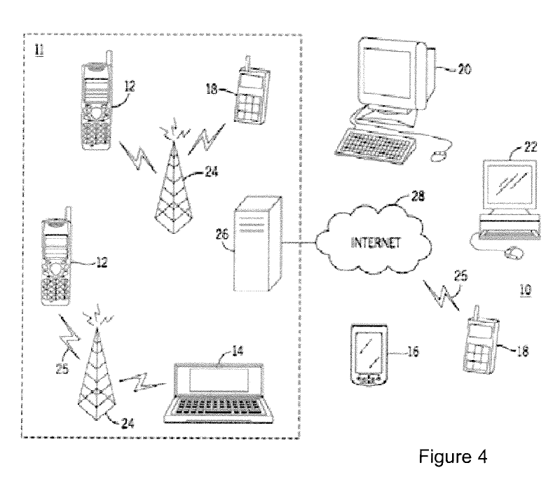

FIG. 4 shows a system 10 in which various embodiments of the present invention can be utilized, comprising multiple communication devices that can communicate through one or more networks. The system 10 may comprise any combination of wired or wireless networks including, but not limited to, a mobile telephone network, a wireless Local Area Network (LAN), a Bluetooth personal area network, an Ethernet LAN, a token ring LAN, a wide area network, the Internet, etc. The system 10 may include both wired and wireless communication devices.

For exemplification, the system 10 shown in FIG. 4 includes a mobile telephone network 11 and the Internet 28. Connectivity to the Internet 28 may include, but is not limited to, long range wireless connections, short range wireless connections, and various wired connections including, but not limited to, telephone lines, cable lines, power lines, TV broadcasting, and the like.

The exemplary communication devices of the system 10 may include, but are not limited to, a combination of personal digital assistant (PDA) and mobile telephone 14, a mobile phone 12, a PDA 16, an integrated messaging device (IMD) 18, a desktop computer 20, a notebook computer 22, etc. The communication devices may be stationary or mobile as when carried by an individual who is moving. The communication devices may also be located in a mode of transportation including, but not limited to, an automobile, a truck, a taxi, a bus, a train, a boat, an airplane, a bicycle, a motorcycle, etc. Some or all of the communication devices may send and receive calls and messages and communicate with service providers through a wireless connection 25 to a base station 24. The base station 24 may be connected to a network server 26 that allows communication between the mobile telephone network 11 and the Internet 28. The system 10 may include additional communication devices and communication devices of different types.

The communication devices may communicate using various transmission technologies including, but not limited to, Code Division Multiple Access (CDMA), Global System for Mobile Communications (GSM), Universal Mobile Telecommunications System (UMTS), Time Division Multiple Access (TDMA), Frequency Division Multiple Access (FDMA), Transmission Control Protocol/Internet Protocol (TCP/IP), Short Messaging Service (SMS), Multimedia Messaging Service (MMS), e-mail, Instant Messaging Service (IMS), Bluetooth, IEEE 802.11, etc. A communication device involved in implementing various embodiments of the present invention may communicate using various media including, but not limited to, radio, infrared, laser, cable connection, and the like.

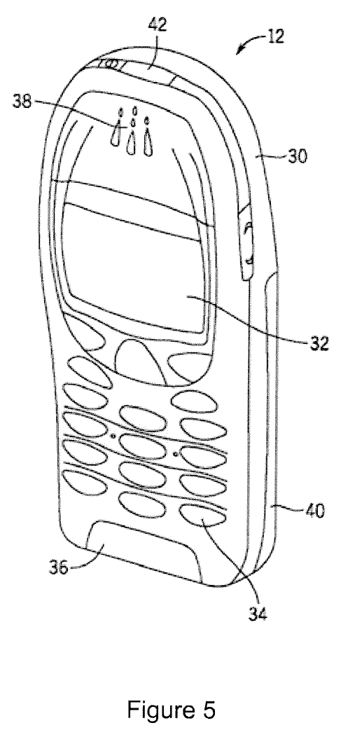

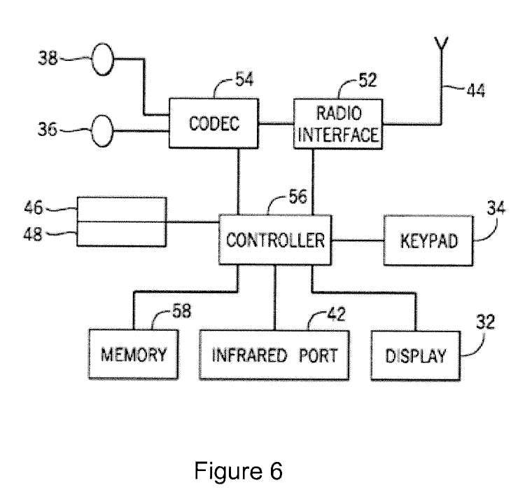

FIGS. 5 and 6 show one representative mobile device 12 within which the present invention may be implemented. It should be understood, however, that the present invention is not intended to be limited to one particular type of mobile device 12 or other electronic device. Some or all of the features depicted in FIGS. 5 and 6 could be incorporated into any or all of the devices represented in FIG. 4. The mobile device 12 of FIGS. 5 and 6 includes a housing 30, a display 32 in the form of a liquid crystal display, a keypad 34, a microphone 36, an ear-piece 38, a battery 40, an infrared port 42, an antenna 44, a smart card 46 in the form of a UICC according to one embodiment of the invention, a card reader 48, radio interface circuitry 52, codec circuitry 54, a controller 56 and a memory 58. Individual circuits and elements are all of a type well known in the art, for example in the Nokia range of mobile telephones.

Various embodiments of the present invention provide systems and methods to perform template matching intra prediction based on a given priority, where the various embodiments can be implemented both at the encoder and decoder levels. According to various embodiments, template matching is performed along with prioritizing blocks based on factors including, but not limited to, a location of the center of the block to be matched and the image/frame content. This center can be located on a boundary separating the block to be intra predicted from an already reconstructed image/frame region, where the image/frame content can refer to that content which resides on the boundary. The template matching further comprises searching a part of or the entirety of the already reconstructed region for the best matching template block. Additionally, residual error is signaled to the decoder by the encoder. It should be noted that various embodiments of the present invention can be applied to both video coding and image coding systems and methods.

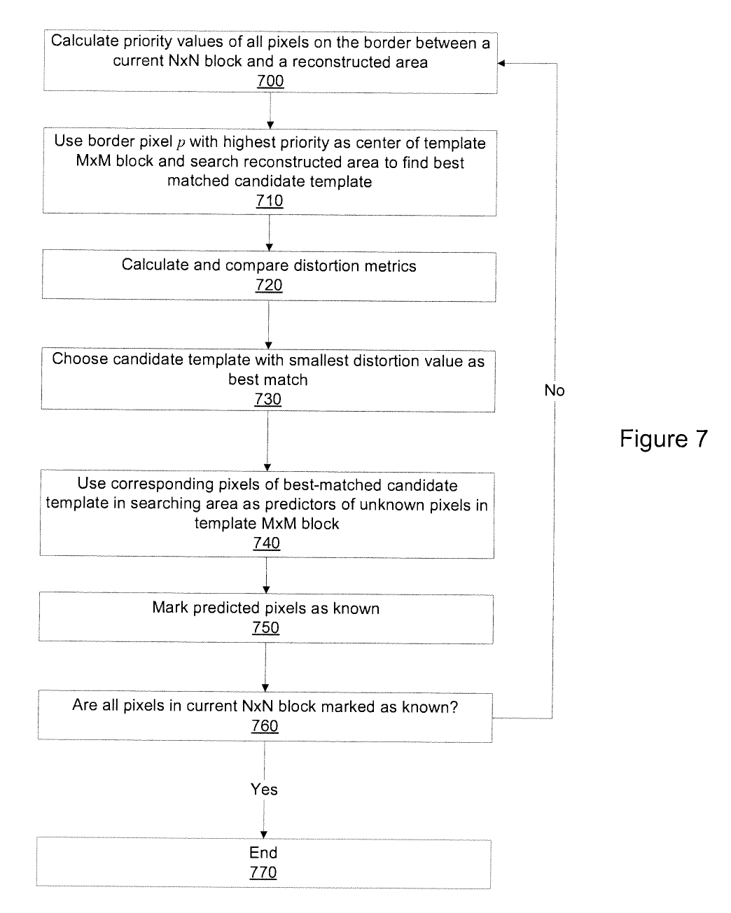

FIG. 7 is a flow chart of processes executed in performing template matching intra prediction in accordance with various embodiments. According to FIG. 7, the priority values of all, or a subset of, the pixels on the border between a current N×N block and a reconstructed area are calculated at 700. A border pixel p with the highest priority is used as the center of a template M×M block, and a search in the reconstructed area is performed to find the best matched candidate template at 710. Distortion metrics, e.g., SAD, between known pixels in the to-match template and corresponding pixels in candidate templates are calculated and compared at 720. The candidate template with the smallest distortion metric value is chosen as the best match at 730. The corresponding pixels of the best-matched candidate template in the searching area are used as the predictors of the unknown pixels in the template centered at the pixel p with the highest priority at 740. The predicted pixels are marked as known at 750. It is determined at 760 whether all of the pixels in the current N×N block are marked as known. If so, the intra prediction process of the current N×N block ends at 770. Otherwise the process is repeated at 700.

It should be noted that for the M×M block, the maximum value of M, i.e., Mₘₐₓ can be fixed or can vary. When Mₘₐₓ varies, it can be signaled from the encoder to the decoder. Therefore, in accordance with some embodiments, M is chosen as large as possible, but not larger than Mₘₐₓ and small enough that the M×M block does not interfere with the non-reconstructed region outside of the N×N block. When Mₘₐₓ is variable, it may vary according to the value of N or the image content.

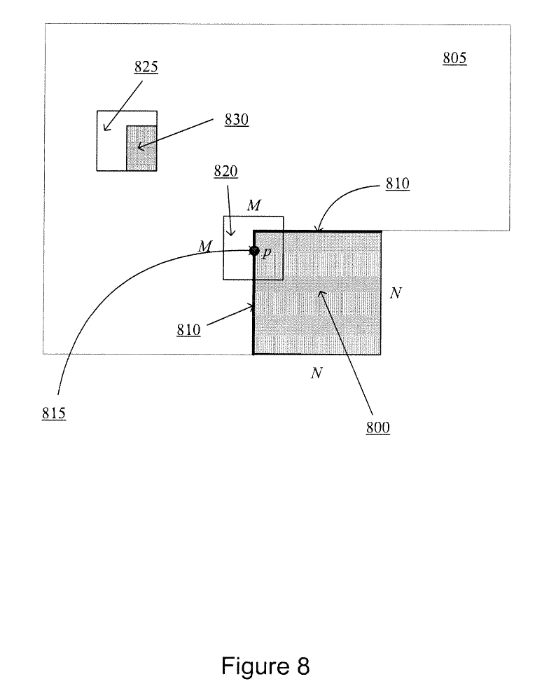

As shown in FIG. 8, the gray region 800, also denoted by Q or N×N, is the current block to be intra predicted, and the region 805 is the reconstructed region, also denoted by Ω̅. The boundary 810, also denoted by ∂Ω, is the boundary between the reconstructed region Ω̅ and the current intra-prediction block Ω. The center p of the M×M block/template 820, denoted by Ψ, is selected from the boundary 810, which has the maximum priority. The value of M can be any value such that the square Ψ covers at least one of the unknown pixels in the current N×N block 800 to be intra predicted. Calculation of the priority value is described below, and it should be noted that the same priority and the same template matching methods described herein can be utilized by both the encoder and the decoder in either a video or image coding system/method/codec. In other words, the encoder and decoder apply the same processes, thus achieving the same result. The known region of the square Ψ can be used as a template matching region to search the candidate template 825 in the reconstructed region using the SAD criterion, where SAD can be calculated (only) from the luma component. After finding the best matched template, the “candidate data” 830 is used to fill in the unknown region in the M×M block 820, and the unknown region is marked as known.

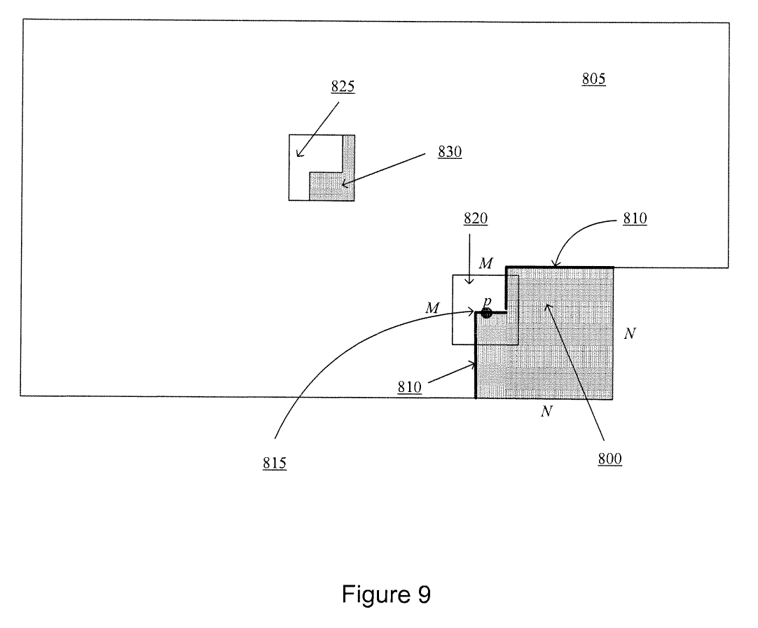

FIG. 9 shows the updated gray region 800 and the boundary 810 after the candidate data filling relative to FIG. 8. In other words, as described above, the corresponding pixels of the best-matched candidate template 830 are utilized to predict the unknown pixels in the M×M block 820. The above operation is repeated as described above until the entire N×N region 800 is filled in. The filled-in sample values are then used as the prediction of the current intra-prediction block 800.

It should be noted that candidate templates, such as candidate template 830 can be any M×M block in the already reconstructed region 805 or alternatively, in a portion of the already reconstructed region 805. Additionally, the search area within the reconstructed region 805 can be limited, for example, to a predetermined area to reduce the computational complexity of search process effectuated therein. Alternatively, a list of predefined candidate templates may be utilized, where the predefined candidate templates are known to both the encoder and the decoder.

As described above, the pixel p with the highest priority is utilized as the center of the M×M block 820. In one embodiment, the priority can be defined as follows:

P(p)=C(p)+D(p) (2)

C(p) and D(p) are defined as follows:

$$C ( p ) = \frac{{\sum }_{q ∈ {Ψ}_{p} ⋂ \overline{Ω}} C ( q )}{\vert {Ψ}_{p} \vert} , D ( p ) = \frac{\vert ∇ {I}_{p} \cdot {t}_{p} \vert}{α} \qquad ( 3 )$$

C(q)=1, ∀qε Ω̅ and C(q)=0, ∀qε≠, where |Ψₚ| is the number of pixels in Ψ. Therefore, C(p) states the ratio of the known pixels in Ψ and D(p) models the strength of the isophotes hitting the front edge of boundary 810, where the stronger this flow of isophotes is, the higher the priority that is given to the border pixel p. It should be noted that α, where α=255 for the 8-bit luma component, is a normalizing factor for intensities, although a plurality of other values are possible. The vector tₚ is a unit vector tangent to the boundary at point p. For example, if the boundary is horizontal at point p, tₚ can be equal to the vector [1 0] and if the boundary is vertical, tₚ can be equal to the vector [0 1].

In accordance with another embodiment, the metric C(p) and D(p) can be defined differently, where

$$C ( p ) = \frac{min ( {d}_{1} ( p ) , {d}_{2} ( p ) )}{M} .$$

Defined in this manner, d₁(p) is the distance between a point p and the left-most edge of the N×N block 800 to be intra predicted, and d₂(p) can be the distance between a point p and the bottom-most edge of the N×N block 800 to be intra predicted. D(p) can be defined using horizontal edge detection filters (for points p on vertical boundaries of the region to be intra predicted) and using vertical edge filters (for points p on horizontal boundaries of the region to be intra predicted). Furthermore, P(p) can be more generally defined as P(p)=a*C(p)+b*D(p), where a+b=1. It should be noted that various embodiments described herein can assign some priority criteria (, e.g., as a rule) to M×M blocks that result in blocks with different sizes and a certain order in which the blocks are encoded/decoded. In other words, priority can alternatively be achieved through processes, rules, criteria, etc. that favor one template block over others at each stage of intra prediction in the N×N block. However, it should be noted that priority can be defined according to a plurality of different methods other than those described herein.

Additionally, V̅Iₚ is the image gradient at point p. The image gradient V̅Iₚ can be numerically computed using, for example, the pixel value at p and the values of one or more of its reconstructed neighboring pixels.

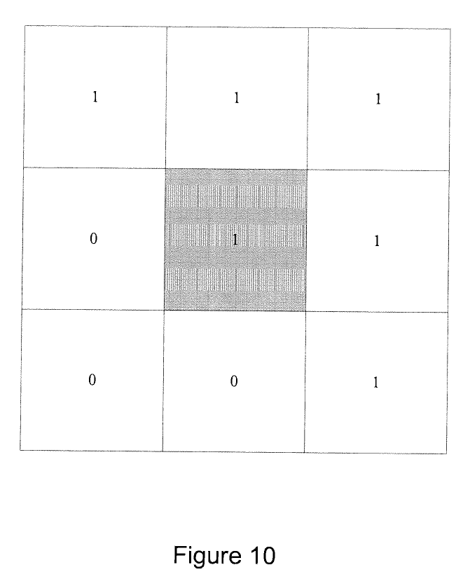

As illustrated in FIG. 10, a mask K(m,n) is defined to represent the known and the unknown pixels. The points marked with a “1” are representative of known pixels and the points marked with a “0” are representative of unknown pixels. The center gray point is p for which nₚ can be calculated. Alternatively, the unit vector tₚ described above can be used.

In order to support the additional intra prediction modes described above, syntax changes to H.264/AVC, for example, are shown below in bolded text. With regard to the derivation process for the Intra4×4PredMode, Table 1 shows an updated specification of Intra4×4PredMode[luma4×4BlkIdx] and associated names. It should be noted that the additional intra prediction modes described above can be applied to other standards as well, where alternative methods of signaling the use of template matching intra prediction to the decoder can be supported.

TABLE 1

| Intra4x4PredMode | |
|---|---|
| [luma4x4BlkIdx] | Name of Intra4x4PredMode[luma4x4BlkIdx] |
| 0 | Intra_4x4_Vertical (prediction mode) |
| 1 | Intra_4x4_Horizontal (prediction mode) |
| 2 | Intra_4x4_DC (prediction mode) |
| 3 | Intra_4x4_Diagonal_Down_Left (prediction |
| | mode) |
| 4 | Intra_4x4_Diagonal_Down_Right (prediction |
| | mode) |
| 5 | Intra_4x4_Vertical_Right (prediction mode) |
| 6 | Intra_4x4_Horizontal_Down (prediction mode) |
| 7 | Intra_4x4_Vertical_Left (prediction mode) |
| 8 | Intra_4x4_Horizontal_Up (prediction mode) |
| 9 | Intra_4x4_Inpainting (prediction mode) |

The variable Intra4×4PredMode is derived by applying the following procedure:

predIntra4x4PredMode = Min( intraMxMPredModeA,
intraMxMPredModeB )
if( predIntra4x4PredMode == Intra_4x4_Inpainting)
predIntra4x4PredMode = Intra_4x4_DC
if( prev_intra4x4_pred_mode_flag[ luma4x4BlkIdx ] )

Intra4x4PredMode = predIntra4x4PredMode

else

if( rem_intra4x4_pred_mode[ luma4x4BlkIdx ] <
predIntra4x4PredMode )

Intra4x4PredMode =
rem_intra4x4_pred_mode[ luma4x4BlkIdx ]

else

Intra4x4PredMode =
rem_intra4x4_pred_mode[ luma4x4BlkIdx ] + 1

With regard to the derivation process for the Intra8×8PredMode, Table 2 shows an updated specification of Intra8×8PredMode[luma8×8BlkIdx] and associated names.

TABLE 2

| Intra8x8PredMode | |
|---|---|
| [luma8x8BlkIdx] | Name of Intra8x8PredMode[luma8x8BlkIdx] |
| 0 | Intra_8x8_Vertical (prediction mode) |
| 1 | Intra_8x8_Horizontal (prediction mode) |
| 2 | Intra_8x8_DC (prediction mode) |
| 3 | Intra_8x8_Diagonal_Down_Left (prediction |
| | mode) |
| 4 | Intra_8x8_Diagonal_Down_Right (prediction |
| | mode) |
| 5 | Intra_8x8_Vertical_Right (prediction mode) |
| 6 | Intra_8x8_Horizontal_Down (prediction mode) |
| 7 | Intra_8x8_Vertical_Left (prediction mode) |
| 8 | Intra_8x8_Horizontal_Up (prediction mode) |
| 9 | Intra_8x8_Inpainting (prediction mode) |

Given an intraM×MPredModeA and intraM×MPredModeB, the variable Intra8×8PredMode is derived by applying the following procedure:

predIntra8x8PredMode = Min( intraMxMPredModeA,
intraMxMPredModeB )
if( predIntra8x8PredMode== Intra_8x8_Inpainting )
predIntra8x8PredMode = Intra_8x8_DC
if( prev_intra8x8_pred_mode_flag[ luma8x8BlkIdx ] )

Intra8x8PredMode = predIntra8x8PredMode

else

if( rem_intra8x8_pred_mode[ luma8x8BlkIdx ] <
predIntra8x8PredMode )

Intra8x8PredMode =
rem_intra8x8_pred_mode[ luma8x8BlkIdx ]

else

Intra8x8PredMode =
rem_intra8x8_pred_mode[ luma8x8BlkIdx ] + 1

An updated macroblock prediction syntax is also shown in Table 3 below.

TABLE 3

| | | |
|---|---|---|
| mb_pred( mb_type ) { | C | Descriptor |

if( MbPartPredMode( mb_type, 0 ) == Intra_4x4 ||

MbPartPredMode( mb_type, 0 ) == Intra_8x8 ||
MbPartPredMode( mb_type, 0 ) == Intra_16x16 ) {
if( MbPartPredMode( mb_type, 0 ) == Intra_4x4 )

for( luma4x4BlkIdx=0; luma4x4BlkIdx<16; luma4x4BlkIdx++ ) {

| | |
|---|---|
| inpainting_intra4x4_pred_mode_flag[ luma4x4BlkIdx ] | u(1) \| ae(v) |
| if( | |

!inpainting_intra4x4_pred_mode_flag[ luma4x4BlkIdx ] )

| { | | |
|---|---|---|
| prev_intra4x4_pred_mode_flag[ luma4x4BlkIdx ] | 2 | u(1) \| ae(v) |
| if( !prev_intra4x4_pred_mode_flag[ luma4x4BlkIdx ] ) | | |

| | | |
|---|---|---|
| rem_intra4x4_pred_mode[ luma4x4BlkIdx ] | 2 | u(3) \| ae(v) |

}

}

if( MbPartPredMode( mb_type, 0 ) == Intra_8x8 )

for( luma8x8BlkIdx=0; luma8x8BlkIdx<4; luma8x8BlkIdx++ ) {

| | |
|---|---|
| inpainting_intra8x8_pred_mode_flag[ luma8x8BlkIdx ] | u(1) \| ae(v) |
| if( | |

!inpainting_intra8x8_pred_mode_flag[ luma8x8BlkIdx ] )

| { | | |
|---|---|---|
| prev_intra8x8_pred_mode_flag[ luma8x8BlkIdx ] | 2 | u(1) \| ae(v) |
| if( !prev_intra8x8_pred_mode_flag[ luma8x8BlkIdx ] ) | | |

| | | |
|---|---|---|
| rem_intra8x8_pred_mode[ luma8x8BlkIdx ] | 2 | u(3) \| ae(v) |

}

}

if( chroma_format_idc != 0 )

| | | |
|---|---|---|
| intra_chroma_pred_mode | 2 | ue(v) \| ae(v) |

} else if( MbPartPredMode( mb_type, 0 ) != Direct ) {
...
}

}

Setting the inpainting_intra4×4_pred_mode_flag[luma4×4BlkIdx] equal to 1 specifies that Intra_{—}4×4_Inpainting is used for the 4×4 luma blocks with an index luma4×4BlkIdx=0 . . . 15. Setting the inpainting_intra4×4_pred_mode_flag[luma4×4BlkIdx] equal to 0 specifies that Intra_{—}4×4_Inpainting is not used for the 4×4 luma blocks with index luma4×4BlkIdx=0 . . . 15.

Likewise, setting the inpainting_intra8×8_pred_mode_flag[luma8×8BlkIdx] equal to 1 specifies that Intra_{—}8×8_Inpainting is used for the 8×8 luma block with an index luma8×8BlkIdx=0 . . . 3. Setting the inpainting_intra8×8_pred_mode_flag[luma8×8BlkIdx] equal to 0 specifies that Intra_{—}8×8_Inpainting is not used for the 8×8 luma block with index luma8×8BlkIdx=0 . . . 3.

The present invention is described in the general context of method steps, which may be implemented in one embodiment by a program product including computer-executable instructions, such as program code, executed by computers in networked environments. Generally, program modules include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps.

Software and web implementations of the present invention could be accomplished with standard programming techniques with rule based logic and other logic to accomplish the various database searching steps, correlation steps, comparison steps and decision steps. It should also be noted that the words “component” and “module,” as used herein and in the claims, is intended to encompass implementations using one or more lines of software code, and/or hardware implementations, and/or equipment for receiving manual inputs.

The foregoing description of embodiments of the present invention have been presented for purposes of illustration and description. It is not intended to be exhaustive or to limit the present invention to the precise form disclosed, and modifications and variations are possible in light of the above teachings or may be acquired from practice of the present invention. The embodiments were chosen and described in order to explain the principles of the present invention and its practical application to enable one skilled in the art to utilize the present invention in various embodiments and with various modifications as are suited to the particular use contemplated.

What is claimed is:

1. A method of encoding, comprising:
prioritizing template blocks according to at least one criterion known to at least an encoder, wherein the template blocks include at least a portion of a to-be-intra predicted block and a reconstructed region;
searching the reconstructed region for a best matched candidate template to match up with the prioritized template block during intra-prediction of the to-be-intra predication block;
predicting unknown pixels of the to-be-intra predicted block utilizing corresponding pixels of the best matched candidate template; and
marking predicted pixels as known.

2. The method of claim 1 further comprising, calculating and comparing distortion metrics between known pixels in the template box and the corresponding pixels of the best matched candidate template.

3. The method of claim 2, where the distortion metrics comprise sums of absolute differences between the known pixels in the template box and the corresponding pixels of the best matched candidate template.

4. The method of claim 3, wherein the sums of absolute differences may be calculated from a luma component of an image signal represented at least in part by the to-be-intra predicted block.

5. The method of claim 2, wherein the best matched candidate template comprises a candidate template having a smallest distortion metric value.

6. The method of claim 1, wherein the calculating, the searching, the predicting, and the marking is repeated until all of the unknown pixels have been marked as known.

7. The method of claim 1, wherein a size of the template block is chosen to be as large as possible without exceeding a maximum value and small enough not to interfere with a non-reconstructed region outside of the reconstructed region.

8. The method of claim 7, wherein the maximum value can be one of a fixed value and a variable value.

9. The method of claim 7, wherein when the maximum value is a variable value, the maximum value is signaled to a decoder and may vary based upon a size of the reconstructed region or based on the image content.

10. The method of claim 1, wherein the best matched candidate template is one of located entirely within the reconstructed region and located in a portion of the reconstructed region.

11. The method of claim 1, wherein the searching of the reconstructed region is limited to a predetermined area.

12. The method of claim 1, wherein the searching of the reconstructed region for the best matched candidate template further comprises searching a list of predefined candidate templates.

13. The method of claim 1, wherein the prioritizing of the template blocks comprises calculating priority values of all, or a subset, of border pixels between the to-be-intra predicted block and the reconstructed region.

14. The method of claim 1, wherein the at least one template block is centered at a highest priority border pixel.

15. The method of claim 14, wherein the highest priority border pixel is determined by a function of ratio of already known pixels in the template block and a function of strength of isophotes hitting a front edge of a border containing the border pixels.

16. The method of claim 14, wherein the highest priority border pixel is determined by a function of distances between the highest priority border pixel and a left-most edge of the to-be-intra predicted block and a bottom-most edge of the to-be-intra predicted block, and a function of horizontal and vertical edge filtered values associated with the highest priority border pixel.

17. The method of claim 1 further comprising, defining a mask representative of the unknown pixels and already known pixels.

18. The method of claim 1 further comprising, computing and coding residual error for the predicted pixels within an intra predicted block resulting from the intra prediction of the to-be-intra predicted block.

19. A computer program product, embodied on a computer-readable medium, comprising computer code configured to perform the processes of claim 1.

20. An apparatus, comprising:
a processor; and
a memory unit communicatively connected to the processor and including:
computer code configured to prioritize template blocks according to at least one criterion known to at least an encoder, wherein the template blocks include at least a portion of a to-be-intra predicted block and a reconstructed region;
computer code configured to search the reconstructed region for a best matched candidate template to match up with the prioritized template blocks during intra-prediction of the to-be-intra predication block;
computer code configured to predict unknown pixels of the to-be-intra predicted block utilizing corresponding pixels of the best matched candidate template; and
computer code configured to mark predicted pixels as known.

21. The apparatus of claim 20, wherein the memory unit further comprises computer code configured to calculate and compare distortion metrics between known pixels in the template box and the corresponding pixels of the best matched candidate template.

22. The apparatus of claim 21, wherein the best matched candidate template comprises a candidate template having a smallest distortion metric value.

23. The apparatus of claim 20, wherein the calculating, the searching, the predicting, and the marking is repeated until all of the unknown pixels have been marked as known.

24. The apparatus of claim 20, wherein the memory unit further comprises computer code configured to define a mask representative of the unknown pixels and already known pixels.

25. The method of claim 20, wherein the memory unit further comprises computer code configured to compute and code residual error for the predicted pixels within an intra predicted block resulting from the intra prediction of the to-be-intra predicted block.

26. A method of decoding, comprising:
receiving a coded representation of an image block;
prioritizing template blocks according to at least one criterion known to at least an encoder, wherein the template blocks include at least a portion of a to-be-intra predicted block and a reconstructed region;
searching the reconstructed region for a best matched candidate template to match up with the prioritized template blocks during intra-prediction of the to-be-intra predication block;
predicting unknown pixels of the to-be-intra predicted block utilizing corresponding pixels of the best matched candidate template;
marking predicted pixels as known;
creating an intra predicted representation of the to-be-intra predicted block; and
reconstructing the image block utilizing the intra predicted representation of the to-be-intra predicted block.

27. The method of claim 26 further comprising, calculating and comparing distortion metrics between known pixels in the template box and the corresponding pixels of the best matched candidate template.

28. The method of claim 27, wherein the distortion metrics comprise sums of absolute differences between the known pixels in the template box and the corresponding pixels of the best matched candidate template.

29. The method of claim 27, wherein the best matched candidate template comprises a candidate template having a smallest distortion metric value.

30. The method of claim 26, wherein the calculating, the searching, the predicting, and the marking is repeated until all of the unknown pixels have been marked as known.

31. The method of claim 26, wherein a size of the template block is chosen to be as large as possible without exceeding a maximum value and small enough not to interfere with a non-reconstructed region outside of the reconstructed region.

32. The method of claim 31, wherein the maximum value can be one of a fixed value and a variable value.

33. The method of claim 32 further comprising, receiving the maximum value when the maximum value is variable, wherein the maximum value varies based upon a size of the reconstructed region.

34. The method of claim 26, wherein the best matched candidate template is one of located entirely within the reconstructed region and located in a portion of the reconstructed region.

35. The method of claim 26, wherein the searching of the reconstructed region is limited to a predetermined area.

36. The method of claim 26, wherein the searching of the reconstructed region for the best matched candidate template further comprises searching a list of predefined candidate templates.

37. The method of claim 26, wherein the prioritizing of the template blocks comprises calculating priority values of all, or a subset, of border pixels between the to-be-intra predicted block and the reconstructed region.

38. The method of claim 37, wherein the at least one template block is centered at a highest priority border pixel.

39. The method of claim 38, wherein the highest priority border pixel is determined by a function of percentage of already known pixels in the template block and a function of strength of isophotes hitting a front edge of a border containing the border pixels.

40. The method of claim 38, wherein the highest priority border pixel is determined by a function of distances between the highest priority border pixel and a left-most edge of the to-be-intra predicted block and a bottom-most edge of the to-be-intra predicted block, and a function of horizontal and vertical edge filtered values associated with the highest priority border pixel.

41. The method of claim 26 further comprising, defining a mask representative of the unknown pixels and already known pixels.

42. The method of claim 26 further comprising, receiving a residual error associated with the predicted pixels and adding the residual error after the reconstructing of the image block.

43. A computer program product, embodied on a computer-readable medium, comprising computer code configured to perform the processes of claim 26.

44. An apparatus, comprising:
a processor; and
a memory unit communicatively connected to the processor and including:
computer code configured to receive a coded representation of an image block;
computer code configured to prioritize template blocks according to at least one criteria known to at least an encoder, wherein the template blocks include at least a portion of a to-be-intra predicted block and a reconstructed region;
computer code configured to search the reconstructed region for a best matched candidate template to match up with the prioritized template blocks during intra-prediction of the to-be-intra predication block;
computer code configured to predict unknown pixels of the to-be-intra predicted block utilizing corresponding pixels of the best matched candidate template;
computer code configured to mark predicted pixels as known;
computer code configured to create an intra predicted representation of the to-be-intra predicted block; and
computer code configured to reconstruct the image block utilizing the intra predicted representation of the to-be-intra predicted block.

45. The apparatus of claim 44, wherein the memory unit further comprises computer code configured to calculate and compare distortion metrics between known pixels in the template box and the corresponding pixels of the best matched candidate template.

46. The apparatus of claim 45, wherein the best matched candidate template comprises a candidate template having a smallest distortion metric value.

47. The apparatus of claim 44, wherein the calculating, the searching, the predicting, and the marking is repeated until all of the unknown pixels have been marked as known.

48. The apparatus of claim 44, wherein the memory unit further comprises computer code configured to define a mask representative of the unknown pixels and already known pixels.

49. The apparatus of claim 44, wherein the memory unit further comprises computer code configured to receive a residual error associated with the predicted pixels and add the residual error after the reconstructing of the image block.

50. A system, comprising:
an encoder configured to prioritize template blocks according to at least one criterion known to at least an encoder, wherein the template blocks include at least a portion of a to-be-intra predicted block and a reconstructed region, search the reconstructed region for a best matched candidate template to match up with the prioritized template blocks during intra-prediction of the to-be-intra predication block, predict unknown pixels of the to-be-intra predicted block utilizing corresponding pixels of the best matched candidate template, mark predicted pixels as known, and upon all of the predicted pixels being marked as known, and output a coded representation of an image block representative of the to-be-intra predicted block; and
a decoder configured to receive and decode the coded representation of the image block, reprioritize template blocks according to at least one criterion known to at least an encoder, wherein the template blocks include at least a portion of, repeat the search of the reconstructed region for the best matched candidate template to match up with the prioritized template blocks during intra-prediction of the to-be-intra predication block, re-predict the unknown pixels of the to-be-intra predicted block utilizing the corresponding pixels of the best matched candidate template, re-mark the predicted pixels as known, create an intra predicted representation of the to-be-intra predicted block, and reconstruct the image block utilizing the intra predicted representation of the to-be-intra predicted block.

51. The system of claim 50, wherein the best matched candidate template comprises a candidate template having a smallest distortion metric value.
